(19) United States
(12) Patent Application Publication
(10) Pub. No.: US 2007/0110904 A1
(43) Pub. Date: May 17, 2007

(54) Method for producing luminous ceramic article

(76) Inventors: Pai-Hua Chen, Taipei (TW); Bing-Chieh Yu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/280,304

(22) Filed: Nov. 17, 2005

(51) Int. Cl. C09K 11/02; B05D 1/32; B05B 5/00; B05D 3/02

(52) U.S. Cl. 427/374.2; 252/301.4 R; 252/301.36; 252/301.4 F; 427/157; 427/282

(57) ABSTRACT

The present invention relates to a method for producing a luminous ceramic article, in which luminous glaze and a solvent are first mixed and applied on a clay base; and then the clay base is burned in a kiln at a determined temperature and duration. The article can be achieved after the clay is cooled at room temperature. Optionally, a minor component and/or an additive may be added into the luminous glaze. In the present invention, the clay base can be a white glazed brick or a china article and the glaze can be manually coated or sprayed on the base through a screen or a mesh. The article itself will emit light after absorbing and storing photo energy, and thus is a safe and reliable light source with a long lighting duration and no pollution.

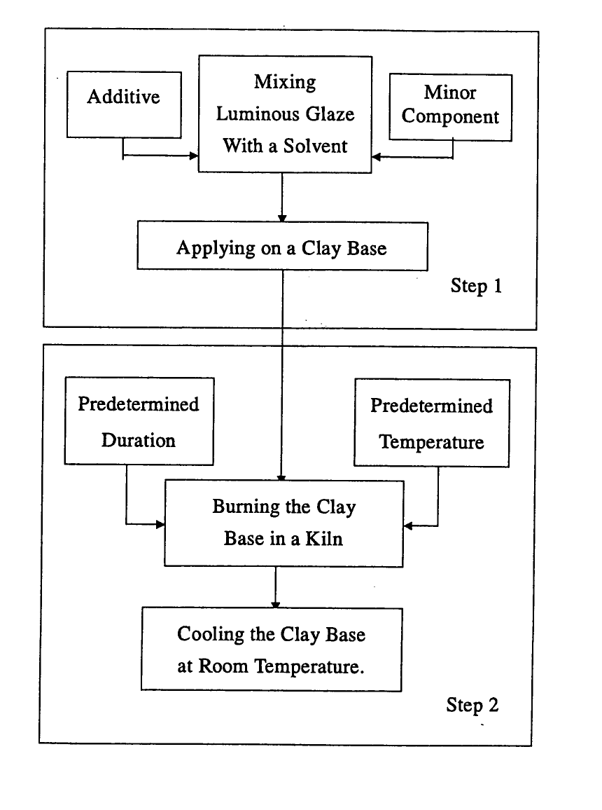

### BACKGROUND OF THE INVENTION

1. Field of the Invention

The present invention relates to a method for producing a luminous ceramic article, which can emit light for a long time, contains no lead, and is achieved after burning. The luminous ceramic article needs no electric power but is able to absorb and store photo energy. When the environment is dark or not bright enough, the energy stored in the article will be transformed into light and emitted.

2. Related Prior Arts

Electric power is always necessary for conventional lamps/bulbs and modern LED lamps but could result in energy crisis and environmental pollutions. Therefore, new light sources with higher reliability but no contamination are constantly developed. Solar energy and hydraulic energy may be the solutions, but high expense and geographic conditions are another problem.

Currently, self-lighting articles such as zinc sulfide illumination and luminous stone are developed. However, zinc sulfide can be lit only for a short time, and pollutants will be generated during the process as lead is used. The luminous stone is usually achieved by adding luminous material into plastic material or resins which are then shaped as particles for being inlaid to stones, or blended with a solvent for being applied on objects. Nevertheless, these conventional luminous materials can not store enough energy to emit light for long time. Moreover, once the coating layer is scratched or destroyed, the light-emitting effect will be severely influenced.

Therefore, it's desired to find a novel lighting source without the above demerits.

### SUMMARY OF THE INVENTION

The object of the present invention is to provide a method for producing a luminous ceramic article, so that chips or fragments of the broken article can be still emit light and recycled.

To achieve the above object, the method of the present invention comprises steps of:

(1) mixing luminous glaze in a solvent and then applied on a clay base; and

(2) burning the clay base in a kiln at a predetermined temperature for a duration and then cooling the base.

The luminous glaze aforementioned can be previously mixed with a minor component and an additive the form a slurry of the luminous glaze and then applied on the base. The clay base can be a white glaze brick or china article burned once. The glaze is usually manually coated or sprayed on the base through a screen. After absorbing and storing photo energy therein, the finished luminous ceramic article will emit light in a dark for a long duration as a reliable light source without pollution.

### BRIEF DESCRIPTION OF THE DRAWING

The FIGURE shows the process according to the method of the present invention.

### DETAILED DESCRIPTION OF THE PREFERRED EMBODIMENTS

In the preferred embodiments of the present invention, luminous ceramic articles are achieved by burning twice. First, clay after burned once, such as white glazed brick, china article or other suitable object, is used as a base. As shown in the FIGURE luminous glaze and a solvent are mixed well and applied on the clay base which is then burned in a kiln at a controlled temperature for a period of time. The article will be achieved after cooling the burned clay.

The luminous glaze used in the present invention can be SrO, Al₂O₃, EU₂O₃, Dy₂O₃ or other rare-earth elements, or a mixture thereof. The luminous glaze also can be previously blended with a minor component and/or an additive to form a slurry of the luminous glaze. The minor component can be one or more of SiO₂, Al₂O₃, Fe₂O₃, CaO, MgO, K₂O, Na₂O, SrO, B₂O₃, ZnO, Li₂O, or other proper material. The additive can be kaolin, cellulose or other proper material.

To explain the formula and procedure of the present invention, six examples are illustrated as follows.

### EXAMPLE 1

The luminous glaze and screen-printing ink are mixed in a ratio of 1:0.5˜1:0.6 by ball milling for 5˜10 minutes to form a slurry of the luminous. Through a screen of 100˜120 meshes, the slurry is applied on the clay base according to designed patterns with a thickness about 0.4˜0.5 mm. Then another layer of transparent glaze powders is applied. After dried at room temperature, the clay is burned in a fast kiln at 850˜1180° C. for 40˜90 minutes. Finally, the luminous ceramic article can be achieved after cooling at room temperature.

### EXAMPLE 2

The luminous glaze and transparent crystal meltage are first mixed in a ratio of 1:1. Through a screen of 100˜120 meshes, the slurry is applied on the clay base according to designed patterns with a thickness about 1.0 mm. Then the clay is burned in a fast kiln at 850˜1180° C. for 40˜90 minutes. Finally, the luminous ceramic article can be achieved after cooling at room temperature.

### EXAMPLE 3

The luminous glaze and screen-printing ink are blended in a ratio of 1:0.4 to form a thick slurry. Through a screen of 40˜60 meshes, the thick slurry is applied on the clay base with a thickness about 0.4˜0.5 mm. After dried at room temperature, a layer of general glaze and a layer of transparent glaze powders are sequentially applied. Then the clay is burned in a fast kiln at 850˜1180° C. for 40˜90 minutes. Finally, the luminous ceramic article can be achieved after cooling at room temperature.

### EXAMPLE 4

The luminous glaze and water are mixed in a ratio of 1:0.5˜1:0.6 and sprayed on the clay base. Then a layer of transparent glaze powders is applied. After dried at room temperature, the clay is burned in a fast kiln at 850˜1180° C. for 40˜90 minutes. Finally, the luminous ceramic article can be achieved after cooling at room temperature.

### EXAMPLE 5

The luminous glaze and water are mixed in a ratio of 1:0.5 and manually applied on the clay base according to designed patterns. After dried at room temperature, the clay is burned in a fast kiln at 850˜1180° C. for 40˜90 minutes. Finally, the luminous ceramic article can be achieved after cooling at room temperature.

### EXAMPLE 6

The luminous glaze is produced as a luminous sticker and capable of being transferred to clay base by attaching thereon. The clay attached with the sticker is then burned in a fast kiln at 850˜1180° C. for 40˜90 minutes. Finally, the luminous ceramic article can be achieved after cooling at room temperature.

By means of the present invention, the luminous ceramic article can absorb photo energy without electricity. The external light sources can be solar light, UV lamps, fluorescent lamps, tungsten lamps, LED lamps, candles, etc. The luminous article of the present invention can absorb energy from these external light sources and store therein. When the external light source is moved, turned off or becomes darker, the stored energy will be transferred into light and emitted. Therefore, the luminous article of the present invention can be simply installed at a proper location without a power connector. According to practical tests, the luminous article of the present invention can continuously emit light for 12 hours or more even if absorbing photo energy for 10˜20 minutes. That is, the luminous article of the present invention performs better than any used currently.

Furthermore, the materials used in the present invention comply with the standard of heavy metal in EN-71, and thus will not cause environmental pollution. The luminous ceramic article of the present invention can be applied to architecture, decoration, emergency/security, public facilities, martial installation, channels, china articles, etc. The luminous article is particularly suitable for an emergency director or sign, so that people can easily find it even though electricity is shut off.

Another important merit of the present invention is that the article can still emit light and be recycled after broken as chips or fragments which is suitable for interior/exterior decoration or other applications.

While the present invention is exemplified with the above examples, any modifications in formula such as additives and solvents or weight/volume ratios thereof can be made by one skilled in this art but still belonged to the scope of the present invention.

What is claimed is:

1. A method for producing a luminous ceramic article, comprising steps of:
(1) mixing luminous glaze in a solvent and then applying on a clay base; and
(2) burning the clay base in a kiln at a predetermined temperature for a period of time, and then cooling the clay base at room temperature.

2. The method as claimed in claim 1, wherein the luminous glaze is Sr₂Al₂O₄:Eu.Dy.

3. The method as claimed in claim 1, wherein the luminous glaze is selected from the group consisting of SrO, Al₂O₃, Eu₂O₃, Dy₂O₃ and other rare-earth elements or a mixture thereof.

4. The method as claimed in claim 1, wherein the solvent is printing ink.

5. The method as claimed in claim 4, wherein the printing ink is screen-printing ink, and the luminous glaze and the screen-printing ink are mixed in a ratio 1:0.5˜1:0.6 by ball milling for 5˜10 minutes to form an slurry of the luminous glaze ceramic, which is then meshed through a screen of 100˜120 meshes and applied on a surface of the clay base in a thickness about 0.4˜0.5 mm, and then the clay base is applied with a layer of transparent glaze powders, dried at room temperature, burned at 850˜1180° C. for 40˜90 minutes and finally cooled at room temperature.

6. The method as claimed in claim 4, wherein the printing ink is screen-printing ink, and the luminous glaze and the screen-printing ink are blended in a ratio about 1:0.4 to form a thick slurry, which is then meshed with a screen of 40˜60 meshes and applied on a surface of the clay base in a thickness about 0.4˜0.5 mm, and the clay base is dried at room temperature, overprinted with general glaze, applied with a layer of transparent glaze powders, dried at room temperature, and burned at 850˜1180° C. for 40˜90 minutes and finally cooled at room temperature.

7. The method as claimed in claim 1, wherein the solvent is transparent crystal meltage, and the luminous glaze and the transparent crystal meltage are mixed in a ratio 1:1, which is then meshed with a screen on 100˜120 meshes and applied on a surface of the clay base in a thickness of 1 mm, and the clay base is burned at 850˜1180° C. for 40˜90 minutes and finally cooled at room temperature.

8. The method as claimed in claim 1, wherein the luminous glaze is further mixed with a minor component and an additive to form an slurry of the luminous glaze.

9. The method as claimed in claim 8, wherein the minor component is selected from the group consisting of SiO₂, Al₂O₃, Fe₂O₃, CaO, MgO, K₂O, Na₂O, SrO, B₂O₃, ZnO and Li₂O, or a mixture thereof.

10. The method as claimed in claim 8, wherein the additive is selected from the group consisting of kaolin and cellulose, or a mixture thereof.

11. The method as claimed in claim 8, wherein the luminous glaze is mixed with water in a predetermined ratio, and then sprayed on the clay base, the clay base is then applied with a layer of transparent glaze powders, dried at room temperature, burned at 850˜1180° C. for 40˜90 minutes and finally cooled at room temperature.

12. The method as claimed in claim 11, wherein the luminous glaze is mixed with water in a ratio 1:0.5˜1:0.6.

13. The method as claimed in claim 8, wherein the luminous glaze and the solvent are mixed in a predetermined ratio, and then manually coated on the clay base, dried at room temperature, burned at 850˜1180° C. for 40˜90 minutes and finally cooled at room temperature.

14. The method as claimed in claim 13, wherein the solvent is a ceramic printing oil.

15. The method as claimed in claim 13, wherein the solvent is water.

16. The method as claimed in claim 13, wherein the ratio of the luminous glaze to the solvent is 0.1:0.5.

17. The method as claimed in claim 8, wherein the luminous glaze is produced as a luminous ceramic sticker, then attached onto the clay base for applying the glaze thereon, burned at 850˜1180° C. for 40˜90 minutes and finally cooled at room temperature.

18. The method as claimed in claim 1, wherein the clay base is a white glazed brick after burned once.

19. The method as claimed in claim 1, wherein the clay base is a white china clay after burned once.
